(19) United States
(12) Patent Application Publication
(10) Pub. No.: US 2017/0064000 A1
(43) Pub. Date: Mar. 2, 2017

(54) METHOD FOR TRANSMITTING POINT-OF-CARE TESTING DATA

(71) Applicant: Jean-Marie PODVIN, BEUVRY LA FORET (FR)

(72) Inventor: Jean-Marie PODVIN, BEUVRY LA FORET (FR)

(21) Appl. No.: 15/123,257

(22) PCT Filed: Mar. 4, 2015
(86) PCT No.: PCT/FR2015/050528

§ 371 Date: Sep. 2, 2016

(30) Foreign Application Priority Data
Mar. 4, 2014 (FR) 1451760

(51) Int. Cl. H04L 29/08; G01N 35/00; G06F 19/00

(52) U.S. Cl. CPC H04L 67/125; G06F 19/3418; G01N 35/00871; G01N 2035/00881

(57) ABSTRACT

The present invention relates to a method (1) for transmitting biological or biochemical analysis data, for example point-of-care testing, said analysis comprising a pre-analytic phase and an analytic phase. Said method includes:
a step (2) for acquiring implementation of the pre-analytic phase such as to obtain a recording, preferably video;
a step (3) for acquiring the result obtained during the implementation of the analytic phase; and
a transmission step (5) for intangibly transmitting the video recording and the result.

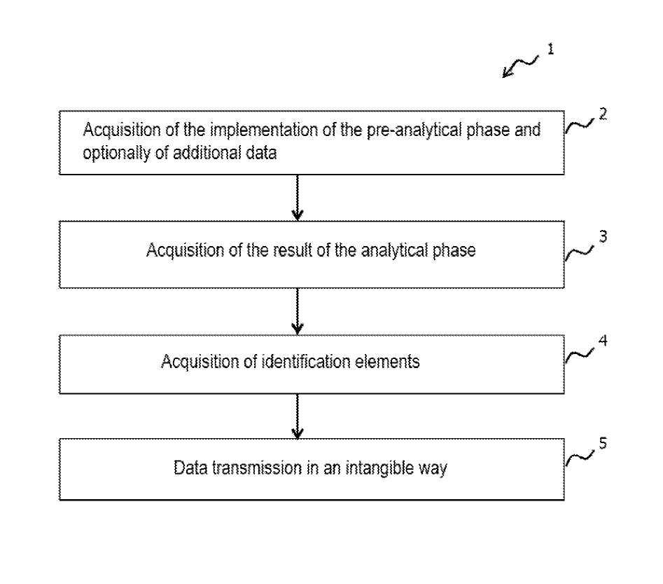

The invention also relates to a method for carrying out point-of-care testing, which includes implementing the data transmission method described above as well as using a device for recording, preferably video and possibly photos, and for transmitting intangible data such as to implement the data transmission method described above.

### BACKGROUND OF THE INVENTION

The present invention relates to the general field of point-of-care analyses, i.e. to analyses conducted outside an analysis laboratory. More particularly, the present invention relates to the field of biological, biochemical or else further medical point-of-care analyses.

Presently there exists a need for the possibility of reliably conducting analyses in a point-of-care situation, in order to allow decisions to be made rapidly and less costly. Such analyses may have to be conducted on the sampling location, for example at home or in the hospital ward in the case of an analysis made on a patient.

However, such analyses, in order to be validated, require control from a biologist or biochemist who should be able to check the procedure which was applied in a point-of-care situation.

There exist biological analysis apparatuses able to measure or evaluate a biological variable in a point-of-care situation. Such apparatuses are generally installed outside a laboratory and very often in an ambulatory department or even at the patient's home. These are generally portable apparatuses, rapid and easy to use. Checking the operation of the ambulatory apparatus is notably known in order to be assured of its proper operation.

However, point-of-care analyses have multiple error sources due to their being carried out outside a laboratory. Thus, even if a checked ambulatory apparatus is used, the sources of errors upstream, downstream or even during the use of the apparatus are still possible thereby modifying the result of the analysis or its interpretation.

### OBJECT AND SUMMARY OF THE INVENTION

The present invention is directed to solving the different technical problems listed earlier. In particular, the present invention is directed to propose a point-of-care analysis method allowing a control similar to the one conducting in a laboratory, i.e. a method giving the possibility of obtaining the same reliability than an analysis in a laboratory.

Thus, according to one aspect, a method for transmitting data of a biological or biochemical analysis, for example at the point-of-care, is proposed, the analysis including a pre-analytical phase and an analytical phase, said method comprising:
a step for acquiring the implementation of the pre-analytical phase in order to obtain a preferably video or audio recording,
a step for acquiring the result obtained during the implementation of the analytical phase, and
a transmission step for transmitting the recording and the result in an intangible way.

Thus, by associating the result of the analysis with the pre-analytical phase, it is possible, during the control of the analysis by a biologist for example, to check the different steps of the applied procedure for the analysis, and therefore to certify its proper implementation. The method according to the invention therefore gives the possibility of guaranteeing the reliability of the obtained result by associating therewith the preceding steps for implementation of the analysis: Traceability of the conducted analysis is therefore achieved.

Preferentially, the method also comprises a step for acquiring geolocalization data, and the transmission step also includes the transmission of geolocalization data. The geolocalization data give the possibility of determining the location where the analysis was conducted, and thereby determining certain pieces of information relating to the implementation of the analysis. For example, when the analysis is conducted in an assistance vehicle such as an ambulance, it is possible to determine whether the vehicle is at a standstill or in motion during the analysis, which may optionally modify the result of the latter.

Preferentially, the step for acquiring geolocalization data is carried out several times during the analysis, for example by multiple acquisition of geolocalization data by satellite (GPS) and/or by acquisition of displacement data for example obtained by an inertial unit. Thus, the displacement of the location where the analysis is conducted may be determined by successive geolocalization measurements, or by the use of an inertial unit giving the possibility of determining the different displacements performed.

Preferentially, the method also comprises a step for acquiring local data, for example temperature, pressure, humidity of the air, altitude, storage conditions or conditioning of the reagents before the analytical phase, and the transmission step also includes the transmission of local data. The local data give the possibility of determining the implementation conditions of the pre-analytical phase and of the analytical phase of the analysis. Therefore they may contribute to the interpretation of the result of the analysis and may therefore be necessary for traceability.

Preferentially, the method also comprises a step for acquiring the time and/or the date, and the transmission step also includes transmission of the date and/or of the time.

Preferentially, the method also comprises a step for acquiring identification elements of the operator carrying out the analysis and/or of identification elements of the devices used for implementation of the analysis or for implementation of the data transmission, and the transmission step also includes transmission of the identification elements of the operator and/or of the devices used. The pieces of information relating to the operator and/or to the devices used for implementing the analysis, have the purpose of observing quality and tracking standards of the analyses carried out.

Preferentially, the pre-analytical phase includes the taking of a sample and optionally its preparation and/or its conditioning. These are different steps implemented before the analytical phase and the implementation of which may have an influence on the result of the analysis.

Preferentially, the analytical phase includes the contacting of the sample with a reagent, the development of the result, and optionally the preparation of said reagent.

Preferentially, the method also comprises a step for acquiring identification elements about the analysis, and the transmission step also includes the transmission of identification elements of the subject of the analysis. The identification elements of the subject may also comprise ancillary elements relating to the subject, such as for example allergies or diseases for a patient.

Preferentially, the method also comprises, before the data transmission step, a step for associating data and identification elements of the subject of the analysis. The association of the identification elements and of the elements relating to the analysis gives the possibility of guaranteeing the origin of the analysis and avoiding permutations between analysis results.

Preferentially, the step for acquiring the implementation of the pre-analytical phase and the step for acquiring the obtained result during the implementation of the analytical phase are achieved by recording at least one video or wherein the step for acquiring the obtained result during the implementation of the analytical phase is achieved by recording at least one photograph. The use of a video or of a photograph facilitates the acquisition of the pre-analytical and analytical data, and gives the possibility of saving time. Moreover, the biologist or biochemist responsible for controlling the analysis will be able to check or locate on the video elements to which the operator will not have paid attention.

According to another aspect, the invention also relates to a method for conducting a biological or biochemical analysis wherein a pre-analytical step and an analytical step and an analysis data transmission method as described earlier are implemented.

According to another aspect, the invention also relates to a use of a recording, preferably video recording device and optionally photographs, of dematerialized data transmission, in order to implement the data transmission method described earlier.

### SHORT DESCRIPTION OF THE DRAWINGS

The invention and advantages thereof will be better understood upon reading the detailed description of a particular embodiment, taken as a non-limiting example and illustrated by the appended drawing on which are illustrated the different successive steps of a method according to the invention.

### DETAILED DESCRIPTION OF THE INVENTION

The appended FIGURE illustrates an example for implementing a data transmission method 1 for a biological or biochemical analysis according to the invention.

The method thus comprises a first step 2 for acquiring the implementation of the pre-analytical phase of the biological or biochemical analysis. The pre-analytical phase may notably comprise the taking of a sample to be analyzed, and its preparation with view to the biological or biochemical analysis to be carried out.

For example, the pre-analytical phase may comprise the taking of a blood sample from a patient. Alternatively, the pre-analytical phase may comprise the taking of a sample from a plant or from an animal with view to detecting the presence of a disease or the absence of noxious or undesirable chemical compounds.

The acquisition of the implementation of the pre-analytical phase may comprise a video or audio recording. It is thus possible to record the different actions implemented during the taking and/or preparation of the sample, which may then be analyzed and validated by an authorized person for validating the analysis, for example by a laboratory assistant.

More specifically, the acquisition of the implementation of the pre-analytical phase may allow better interpretation of the analytical phase, and its validation, even if the person having conducted the pre-analytical phase is not the same person as the one interpreting and validating the analytical phase. It is then possible to validate a biological or biochemical analysis conducted by an unauthorized person for validating the analysis.

The first step 2 may also comprise the acquisition of additional information, such as the temperature, the pressure, the geolocalization, the humidity of the air, the altitude, the conditioning or the storage conditions of the reagent(s), before use, etc. These are conditions for conducting the pre-analytical or analytical phase which may alter or modify the result of the analytical phase. These pieces of information may then be considered at the same time as the acquisition video of the pre-analytical phase, in order to allow interpretation and a more complete and more specific analysis of the results of the analytical phase.

The method 1 then comprises a second step 3 for acquiring the result of the analytical phase. The analytical phase may notably comprise the contacting of the sample to be analyzed and the reagent(s), and the preparation of the reagent(s) with view to the biological or biochemical analysis to be carried out.

For example, the analytical phase may comprise the deposition of the sample into the reagent, its contacting with an electrode or with a plate impregnated with reagent. The analytical phase may also comprise the analysis of the sample by a machine, for example by a device for analyzing the alcohol content contained in air breathed out by a person.

The conducted analysis may thus be determination of the glycemia, before injection of insulin, or else further the determination of the hemoglobin concentration or hematocrit before a hemodilution or transfusion procedure.

The acquisition of the analytical phase may comprise a video recording of the development of the result, or else a photograph of the result obtained at the end of the analytical phase, or further the recording of the result provided by a machine. It is notably this result, in video form or in photographic form or in another form, for example electronic form, which may be the subject, combined with the pre-analytical phase, of an interpretation and validation by an authorized person, for example a biologist or a laboratory assistant.

The method 1 may also comprise a third step 4 for acquiring identification elements. Such identification elements give the possibility of associating the results of the analytical phase with an individual or with an identified sample. The identification elements may thus be the marital status particulars of the person subject of the analysis, or else further of the person conducting the analysis.

This may also be the date and time of the analysis or else further the location where the analysis is conducted, giving the possibility of going back in a second phase to the object of the analysis.

This may also be a code for which only the principal of the analysis is aware of the correspondence with the analyzed sample. It is then possible to keep secret certain elements of the analysis, such as the origin, without compromising the result of the analysis.

The identification elements may also comprise elements relating to the apparatus used for conducting the analytical phase and/or for achieving data transmission. It is thus also possible to also determine the specifications of the apparatus used, and its technical limits may be taken into account for the interpretation of the analysis.

Alternatively, the identification elements may be recorded during the step for acquiring the pre-analytical phase, for example by video recording of identification means such as an identity card or a bar-code corresponding to the analyzed sample.

Alternatively, the identification elements may also comprise pieces of information related to the individual, for example possible allergies, the examinations which may be practiced on him/her and any other information which may be taken into account for interpreting the results or for the follow up to be given to the analysis.

It is thus understood that the step for acquiring identification elements is optional, and may be implemented at any moment before the step for transmitting information, for example before or during the step for acquiring the implementation of the pre-analytical phase.

Finally, in a last step 5, the method 1 comprises a step for transmitting acquired data during steps 2 to 4, intangibly. By intangible is meant any method allowing transmission of information without any physical medium such as a CD, DVD or paper. For example; this may be a wireless transmission, via mobile telephone networks for example, or via other wireless communication protocols such as WIFI or BLUETOOTH transmissions. This may also be a wired transmission via telephone networks or via Internet.

The object of the intangible transmission step is to allow implementation of the analysis in a point-of-care situation, at a distance from the authorized person for validating the result of the obtained result of the analysis. The intangible transmission notably gives the possibility of rapidly transmitting the elements required for validation of the analysis, without any external alteration.

According to an embodiment, the different elements acquired during steps 2 to 4 are associated before the data transmission step 5. For example, the identification elements may be definitively associated for example by tattooing of the recording of the pre-analytical phase or of the result of the analytical phase with the name of the analyzed patient. The association of the identification elements with the analysis elements gives the possibility of ensuring that the obtained and validated results will not be associated, by error or by manipulation, with another analysis. It is then possible to certify the obtained result, relatively to a determined analysis.

Alternatively, the method may also comprise, before the transmission step, a step for encrypting all or part of the transmitted information, in order to guarantee their confidentiality on the one hand and their origin on the other hand without any alteration or subsequent modification before validation.

The invention also relates to a method for carrying out a biological or biochemical analysis wherein a pre-analytical step, an analytical step and the analysis data transmission method 1 described earlier are implemented. In particular, the step for conducting the pre-analytical phase and the step for acquiring the pre-analytical phase are implemented simultaneously.

For the implementation of the method according to the invention, it is possible to use any acquisition and transmission device. Thus, the device used may be a connected device, for example a telephone equipped with a camera and optionally a geolocalization chip, capable of transmitting information such as videos and/or photographs through the mobile telephone networks.

Thus, by means of the method according to the invention, it becomes possible to conduct analyses, both medical, biological or biochemical, in a point-of-care situation, while retaining validation of the obtained result by an authorized person by means of traceability of the procedure used for conducting the analysis. Moreover, by using a recording in a video format and by associating the different pieces of information between them, the absence of modifications of the data are guaranteed before validation, and therefore the obtained result is certified.

1-13. (canceled)

14. A method for transmitting data of a biological or biochemical analysis, the analysis including a pre-analytical phase and an analytical phase, said method comprising:
a step for acquiring the implementation of the pre-analytical phase in order to obtain a recording,
a step for acquiring the obtained result during the implementation of the analytical phase, and
a step for transmission in order to transmit the recording and the result, intangibly.

15. The method according to claim 14 comprising a step for acquiring geolocalization data, and wherein the transmission step also includes transmission of geolocalization data.

16. The method according to claim 15 wherein the step for acquiring geolocalization data is carried out several times during the analysis.

17. The method according to claim 14 also comprising a step for acquiring local data, and wherein the transmission step also includes transmission of local data.

18. The method according to claim 14 also comprising a step for acquiring the time and/or the date, and wherein the transmission step also includes transmission of the date and/or of the time.

19. The method according to claim 14 also comprising a step for acquiring identification elements of the operator conducting the analysis and/or identification elements of the devices used for implementation of the analysis or for implementation of the data transmission, and wherein the transmission step also includes transmission of the identification elements of the operator and/or of the devices used.

20. The method according to claim 14, wherein the pre-analytical phase includes the taking of a sample.

21. The method according to claim 20 wherein the analytical phase includes the contacting of the sample with a reagent, and the development of the result.

22. The method according to claim 14 also comprising a step for acquiring identification elements of the subject of the analysis, and wherein the transmission step also includes transmission of the identification elements of the subject of the analysis.

23. The method according to claim 22 also comprising, before the data transmission step, a step for associating the data and the identification elements of the subject of the analysis.

24. The method according to claim 14 wherein the step for acquiring the implementation of the pre-analytical phase and the step for acquiring the obtained result during the implementation of the analytical phase are carried out by recording at least one video or wherein the step for acquiring the obtained result during the implementation of the analytical phase is carried out by recording at least one photograph.

25. The method according to claim 14 wherein the step for acquiring the implementation of the pre-analytical phase allows to obtain a video recording.

26. The method according to claim 14, for transmitting data of a biological or biochemical analysis at the point of care.

27. The method according to claim 16 wherein the step for acquiring geolocalization data comprises multiple acquisition of geolocalization data by satellite (GPS) and/or by acquisition of displacement data obtained by an inertial unit.

28. The method according to claim 20 wherein the pre-analytical phase includes the preparation of the sample and/or the conditioning of the sample.

29. A method for carrying out a biological or biochemical analysis wherein a pre-analytical step, an analytical step and an analysis data transmission method are implemented according to claim 14.

30. The use of a recording device and for transmitting data intangibly, for implementing the method for transmitting data according to claim 14.

31. The use according to claim 30 wherein the recording device is a video recording device and/or a photograph recording device.
